(19) United States
(12) Patent Application Publication
(10) Pub. No.: US 2025/0342256 A1
(43) Pub. Date: Nov. 6, 2025

(54) SECURITY VULNERABILITY ASSESSMENT USING RUNTIME DATA OF A JUST IN TIME (JIT) ENGINE

(71) Applicant: Oligo Cyber Security, LTD., Tel Aviv-Yafo (IL)

(72) Inventor: Guy Kaplan, Zur Igal (IL)

(21) Appl. No.: 19/174,223

(22) Filed: Apr. 9, 2025

Related U.S. Application Data
(60) Provisional application No. 63/641,628, filed on May 2, 2024.

(51) Int. Cl. G06F 21/57

(52) U.S. Cl. CPC G06F 21/577; G06F 2221/033

(57) ABSTRACT

A method includes executing a program by a Just-in-Time (JIT) engine in a runtime environment, where the JIT engine is configured to store runtime data at an in-process memory and to compile portions of the program based on the runtime data. The method then extracts, by a software agent that is external to a process of the JIT engine, the runtime data from the in-process memory. Based on the runtime data, the method performs a classification of code units of the program as active or inactive code units, where the active code units include at least one function that is indicated by the runtime data as being executed at least once and determining a security vulnerability assessment of the program based on the classification of the code units of the program. Also provided are a computer program product and apparatus for implementing the method.

### CROSS-REFERENCE TO RELATED APPLICATION

This application claims the benefit of Provisional Patent Application No. 63/641,628, entitled “JIT-BASED IDENTIFICATION OF EXECUTED LIBRARIES” filed May 2, 2024, which is hereby incorporated by reference in its entirety without giving rise to disavowment.

### TECHNICAL FIELD

The disclosed subject matter relates to cyber security and, more particularly, but not exclusively to enhancing a software vulnerability assessment.

### BACKGROUND

The rapidly evolving landscape of cybersecurity presents organizations with increasingly complex challenges in safeguarding their software infrastructure. Modern software applications often rely on extensive ecosystems of third-party libraries and packages, which can introduce vulnerabilities into systems without the organization's direct knowledge. Accurately identifying and mitigating these vulnerabilities has become increasingly critical as the complexity and interdependence of software components grow.

Effective vulnerability management requires not only detecting potential weaknesses in these components but also assessing their exploitability, prioritizing remediation efforts, and reducing exposure to potential threats.

### BRIEF SUMMARY

One exemplary embodiment of the disclosed subject matter is a method comprising: executing a program by a Just-in-Time (JIT) engine in a runtime environment, the JIT engine is configured to execute the program without a-priori compiling the program, the JIT engine is configured to store runtime data of an execution of the program at an in-process memory, the JIT engine is configured to compile portions of the program based on the runtime data; extracting, by a software agent that is external to a process of the JIT engine, the runtime data from the in-process memory; based on the runtime data, performing a classification of code units of the program as active code units or inactive code units, wherein each of the active code units comprise at least one function that is indicated by the runtime data as being executed at least once, wherein each of the inactive code units is absent of any function that is indicated by the runtime data as being executed at least once; and determining a security vulnerability assessment of the program, said determining is performed based on the classification of the code units of the program.

Optionally, the method further comprises aggregating the runtime data that is extracted from said extracting, with previously extracted runtime data of the program, thereby obtaining aggregated runtime data, wherein the previously extracted runtime data was extracted by the software agent based on previous executions of the program, and wherein the classification is performed based on the aggregated runtime data.

Optionally, the method further comprises processing the aggregated runtime data to generate runtime metrics, the runtime metrics comprise a function call count, a function execution time, an average execution time of a function, a number of executions of the function, or the like.

Optionally, said determining the security vulnerability assessment comprises prioritizing first vulnerabilities that are associated with the active code units over second vulnerabilities of the inactive code units.

Optionally, said prioritizing the first vulnerabilities comprises removing the second vulnerabilities of the inactive code from the security vulnerability assessment.

Optionally, said prioritizing the first vulnerabilities comprises reducing a risk score of the second vulnerabilities.

Optionally, the security vulnerability assessment is generated from scratch to incorporate the first vulnerabilities and not to incorporate the second vulnerabilities.

Optionally, said determining comprises: obtaining an initial vulnerability assessment that is generated by a third-party application, wherein the initial vulnerability assessment comprises a list of vulnerabilities of code packages of the program; and adjusting the list of vulnerabilities according to the classification of the code units of the program.

Optionally, the list of vulnerabilities comprises a list of Common Vulnerabilities and Exposures (CVEs) and corresponding risk scores.

Optionally, the in-process memory is a heap.

Optionally, said extracting comprises: assigning high access privileges to the software agent, the high access privileges comprise root or administrator privileges in an Operating System (OS) of a host computer used to execute the program; utilizing the high access privileges to attach the software agent to the process of the JIT engine; and the software agent directly accessing the in-process memory via the process.

Optionally, the software agent is external to a runtime environment in which the execution of the program is performed.

Optionally, the classification of the code units is performed according to a granularity level of the security vulnerability assessment, wherein the granularity level comprises one of: a function granularity level, a library granularity level, or a package granularity level.

Optionally, the method further comprises generating a user interface presentation for the security vulnerability assessment of the program, wherein the user interface presentation prioritizes first vulnerabilities of the active code units over second vulnerabilities of the inactive code units.

Another exemplary embodiment of the disclosed subject matter is an apparatus comprising a processor and coupled memory, said processor being adapted to perform: executing a program by a JIT engine in a runtime environment, the JIT engine is configured to execute the program without a-priori compiling the program, the JIT engine is configured to store runtime data of an execution of the program at an in-process memory, the JIT engine is configured to compile portions of the program based on the runtime data; extracting, by a software agent that is external to a process of the JIT engine, the runtime data from the in-process memory; based on the runtime data, performing a classification of code units of the program as active code units or inactive code units, wherein each of the active code units comprise at least one function that is indicated by the runtime data as being executed at least once, wherein each of the inactive code units is absent of any function that is indicated by the runtime data as being executed at least once; and determining a security vulnerability assessment of the program, said determining is performed based on the classification of the code units of the program.

Yet another exemplary embodiment of the disclosed subject matter is a computer program product comprising a non-transitory computer readable medium retaining program instructions, which program instructions when read by a processor, cause the processor to: execute a program by a JIT engine in a runtime environment, the JIT engine is configured to execute the program without a-priori compiling the program, the JIT engine is configured to store runtime data of an execution of the program at an in-process memory, the JIT engine is configured to compile portions of the program based on the runtime data; extract, by a software agent that is external to a process of the JIT engine, the runtime data from the in-process memory; based on the runtime data, perform a classification of code units of the program as active code units or inactive code units, wherein each of the active code units comprise at least one function that is indicated by the runtime data as being executed at least once, wherein each of the inactive code units is absent of any function that is indicated by the runtime data as being executed at least once; and determine a security vulnerability assessment of the program, said determine is performed based on the classification of the code units of the program.

### BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a flowchart diagram of a method, in accordance with some exemplary embodiments of the disclosed subject matter;

FIG. 2 shows a sequence diagram, in accordance with some exemplary embodiments of the disclosed subject matter;

FIG. 3 shows a schematic illustration of an exemplary environment in which the disclosed subject matter may be utilized, in accordance with some exemplary embodiments of the disclosed subject matter;

FIGS. 4A-4B show exemplary displays of security vulnerability assessments, in accordance with some exemplary embodiments of the disclosed subject matter; and

FIG. 5 shows a block diagram of an apparatus, in accordance with some exemplary embodiments of the disclosed subject matter.

### DETAILED DESCRIPTION

One technical problem dealt with by the disclosed subject matter is to enhance a vulnerability assessment process of an organization's software infrastructure. For example, vulnerability assessments may be conducted to enhance cybersecurity of organizations. Traditional methods for security vulnerability assessment of computer code are often inefficient. For example, the traditional methods may be resource-intensive in terms of computational power, memory storage, time, manual labor, or the like. It may be desired to overcome this drawback and minimize the resource consumption of security vulnerability assessments.

Another technical problem dealt with by the disclosed subject matter is to enhance the relevancy of a security vulnerability assessment process. For example, it may be desired to provide a security vulnerability assessment that accurately identifies vulnerabilities within an organization's software infrastructure, while focusing on relevant threats. For example, it may be desired that the security vulnerability assessment will not prioritize or include “noisy” and irrelevant vulnerabilities, such as relating to unused code that is incorporated within the software.

In some exemplary embodiments, traditional methods for security vulnerability assessment may suffer from a high ratio of false positives, in which listed vulnerabilities are “noisy” and irrelevant. For example, irrelevant vulnerabilities may comprise vulnerabilities of inactive code that is not used during the software execution. In some exemplary embodiments, the excessive reliance of modern software infrastructure on libraries and open-source code, may result with a high percent of an application's code remaining unused in runtime, e.g., approximately 80 percent. In some exemplary embodiments, while libraries and open-source code may accelerate code development, they also contribute to a greater number of inactive code components. This increase may lead to security vulnerability assessment processes identifying more vulnerabilities, based on the extensive inactive code. Many of those identified vulnerabilities may have little to no relevance, as the code is inactive.

In some exemplary embodiments, many functions or other code units (e.g., files, classes, packages, or the like) may not be utilized in runtime at all, regardless of the execution environment, parameters, or the like. For example, since developers frequently incorporate entire source code libraries or frameworks to access only a few specific functions, large amounts of inactive code may be included in the application without being executed. As another example, developers may add a new library or package without removing an existing one, rendering the entire older library redundant. As another example, functions may be inactive in case they were used by retired systems (e.g., systems external to the code's application) that are no longer deployed. As another example, functions may be inactive in case they are no longer invoked since the conditions for their invocation by a calling function are never or no longer met. As another example, functions may be inactive in case they were introduced into the code as part of library dependencies that are never actually invoked. In other cases, any other code component may be or become inactive due to any other cause.

In some exemplary embodiments, due to the high volumes of inactive code, security teams may waste valuable resources on investigating irrelevant vulnerabilities in inactive code, while critical vulnerabilities might be overlooked. In some exemplary embodiments, utilizing computing resources to assess security vulnerabilities of a code base that is largely inactive may introduce inefficiency to the process, as parts of the code that are no longer in use continue to consume resources unnecessarily.

For example, a vulnerability found for an inactive function that is never executed by an application may have low to no significance to the application. In some exemplary embodiments, the insignificant and inactive vulnerabilities may be regarded as “noise”, e.g., irrelevant or redundant data that distracts from genuine security threats. In some exemplary embodiments, it may be desired to overcome this drawback, and reduce the noise from vulnerability assessments. For example, it may be desired to direct the resources of the vulnerability assessments to relevant vulnerabilities of active code.

Yet another technical problem dealt with by the disclosed subject matter is to identify potential security risks such as vulnerabilities in code components of a program that are active. For example, it may be desired to identify vulnerabilities of code components that are invoked by the program's executions.

Yet another technical problem dealt with by the disclosed subject matter is to identify which code components are active. It may be desired to identify the active components in an efficient manner. For example, it may be desired to identify active code components without consuming high volumes of computational resources, time resources, or the like. In some cases, it may be desired to overcome drawbacks of tracking methods that are highly inefficient, such as methods of tracking operating system files that are launched, to identify active code components. As another example, profiling tools may utilize instrumentation in order to identify which code units are invoked in the code. However, instrumentation adversely affects the performance of the software. In some cases, instrumentation may cause significant slowdown due to overhead associated therewith.

Yet another technical problem dealt with by the disclosed subject matter is to identify active and inactive code components in interpreter-based programming languages, such as Python and JavaScript. Interpreter-based languages are widely used these days. However, identifying which part of the code was executed may be a non-trivial task in programs that were programmed using such languages.

One technical solution of the disclosed subject matter is to identify inactive code of a program that is being assessed for vulnerabilities, and to adjust a vulnerability assessment of the program accordingly. In some exemplary embodiments, the disclosed subject matter is configured to leverage a Just-in-Time (JIT) compilation and execution framework, also referred to as the “JIT engine”, to enable a high speed and lightweight detection of inactive code of the program, which may reduce the processing time and overhead compared to alternative methods. In some exemplary embodiments, after identifying the inactive code, a security vulnerability assessment of the program may be applied to the active code exclusively, or may be adjusted based on the identified inactive code.

For example, a vulnerability analysis of a program may present a list of vulnerabilities such as Common Vulnerabilities and Exposures (CVE) vulnerabilities, a risk score of listed CVEs, or the like. According to this example, identified inactive code and/or active code may be used to adjust the list of vulnerabilities, such as by removing vulnerabilities of inactive code, reducing a risk score of vulnerabilities of inactive code, or the like, thereby reducing false positives, reducing noise, and focusing on relevant vulnerabilities. In other cases, the list of vulnerabilities may be generated anew for the active code exclusively, thereby identifying only significant vulnerabilities of code areas that were utilized by the program in runtime.

In some exemplary embodiments, in order to identify inactive code of a program, the JIT engine may be leveraged to identify all functions, libraries, and packages that were invoked at least once during runtime. In some exemplary embodiments, a code unit that is executed at least once during runtime of the program may be classified as an active code unit, while a code unit that is not executed even once may be classified as an inactive code unit.

In some exemplary embodiments, a program for which the vulnerability assessment is applied may comprise any software application, web-based application, desktop application, cloud-based application, firmware code, database system, software package, software module, or the like. In some cases, the program may be referred to as an “application”. In some exemplary embodiments, the program may comprise a code base, which may be inspected for vulnerabilities and which may comprise at least some inactive code units or components. For example, the program may comprise a software package, comprising a collection of software modules, functions and code components grouped together to provide a specific functionality. As another example, the program may comprise a plurality of functions, each of which comprising a block of code that performs a defined task. In some cases, the program may or may not import and utilize one or more libraries, such as open-source libraries. In some exemplary embodiments, the code units of the program may refer to components of the program such as functions, libraries, code packages, or the like.

In some exemplary embodiments, the program for which the vulnerability assessment is applied may be executable in one or more runtime environments, such as in environments that support a JIT engine. For example, the JIT engine may be operable within runtime environments such as Python™, JavaScript™, Ruby™, .NET, Java™ Virtual Machine (JVM), Node.js™, or the like.

In some exemplary embodiments, the JIT engine may be leveraged for high speed and lightweight detection of inactive code, at least since the JIT engine may be configured to track executions of program functions.

In some exemplary embodiments, a JIT engine may be in charge to implement the Just-in-Time compilation scheme for the program. In some exemplary embodiments, the JIT engine may comprise a plurality of components, such as an interpreter, a monitoring component, an optimizer, a garbage collector component, or the like.

In some exemplary embodiments, the JIT engine may comprise at least one interpreter for interpreting the program's code. In some cases, the interpreter may obtain code of a software program. The code may be provided in human-readable form or in a format that is not machine-specific, such as bytecode. For example, the program's code may be precompiled into an intermediate representation such as bytecode by a traditional compiler (also referred to as the “Baseline Compiler”) or another processing tool. In other cases, the interpreter may obtain code without a pre-compilation stage, such as by obtaining source code of the program directly. In some exemplary embodiments, the code obtained by the interpreter may be referred to as “program code”.

In some exemplary embodiments, during runtime, the interpreter may execute the program code directly, processing instructions line by line or statement by statement, without converting the instructions into machine code. For example, this process may allow the program to run immediately, without further processing stages. Specifically, the interpreter executes the program code without compiling the program code.

In some exemplary embodiments, during code execution by the interpreter, a monitoring component of the JIT engine such as a profiler component may be configured to collect execution data and analyze the execution data to identify code paths that are frequently executed (also referred to as “hot spots”). For example, a code unit may be classified as a hot spot in case it was executed, during the program execution, a number of times that is greater than a threshold, greater than a defined ratio, in a frequency that exceeds a threshold, or the like. As another example, a code unit may be classified as a hot spot in case it is scheduled to be executed a number of times that is greater than a threshold during a program execution. In some exemplary embodiments, the profiler may collect data regarding the hot spots, thereby determining which functions or blocks of code are executed most frequently. For example, the profiler may identify that a particular function is called hundreds of times, while others are called less times.

In one scenario, such as in a JavaScript runtime environment, the profiler may comprise a JavaScript Profiler that identifies the portions of the program that are executed most frequently by monitoring the execution flow of the JavaScript code as it is interpreted, executed, or the like. The profiler may identify frequently used code, and extract the most commonly executed code from the JavaScript source code.

In some exemplary embodiments, the profiler may report the collected execution data to a JIT compiler of the engine. In some exemplary embodiments, the JIT compiler may be configured to optimize frequently-executed code portions in order to improve the performance of the program's execution. In some exemplary embodiments, the JIT compiler may decide, based on the reported execution data, which sections of the program code should be optimized and compiled to machine code. For example, the JIT compiler may apply a heuristic, rule, optimizer engine, or the like, to determine which functions and/or code units should be compiled. In other cases, the JIT compiler may automatically compile all the hot spots that are indicated by the profiler to machine code. For example, the JIT compiler may compile the program code of the identified hot spots into machine code.

In some exemplary embodiments, the JIT compiler may translate at least some

hot spots into machine code that is optimized for the specific Central Processing Unit (CPU) architecture on which the program is running. For example, the JIT compiler may comprise one or more translation components (e.g., a “Bytecode to Machine Code Translator” component), configured to translate code from an intermediate form like bytecode, into machine code specific to the processor's architecture. As another example, the JIT compiler may comprise one or more translation components configured to translate source code into machine-specific code. In some cases, the resulting machine code may comprise CPU-specific instructions that can be directly executed by the CPU, bypassing the need for interpretation.

In some exemplary embodiments, the machine code of the hot spots may be retained in the memory for reuse for future invocations of the hot spots, during the program execution. In some cases, the machine code may be reused for executing subsequent hot spots during the remaining program execution. In some exemplary embodiments, once the machine code for hot spots is retained in memory, execution may continue in a hybrid model: the interpreter may process the sections of the program that are not compiled, line by line or statement by statement, as usual, while sections that were compiled (e.g., hot spots) are executed directly using the machine code, e.g., without utilizing the interpreter. As direct execution using machine code has improved performance compared to interpreter-based execution, such a scheme enables increased performance by improving performance with respect to commonly executed portions.

In some exemplary embodiments, the translation of the program code of the hot spots into machine code may be performed in the background while the interpreter continues to run other parts of the program that haven't been optimized yet. For example, in case the other parts of the program comprise the translated hot spots, their interpretation may be replaced with an execution of the machine code. As another example, in a program with at least two lines of code, where the second line calls a function that is frequently used, the JIT engine may identify this function as a hot spot.

Instead of repeatedly interpreting the function call, the JIT compiler may translate the function's code into machine code. In subsequent executions of the program, when the program reaches the second line of code, the JIT engine may directly execute the compiled machine code for the function, bypassing the interpretation step. The first line of the program, however, may still be interpreted as usual.

In some exemplary embodiments, the JIT compilation process of the program may retain information that relates to the monitoring of hot spots, such as a count of function calls. In some exemplary embodiments, the JIT compilation process may retain such information (“runtime data”) at an in-process memory, which may not necessarily be accessible to a vulnerability assessment performed or other external processes.

In some exemplary embodiments, runtime environments may facilitate the buffer, or short-term storage, of runtime data regarding the program's execution. In some exemplary embodiments, runtime data may be generated by a JIT framework when executing computer programs and may be retained locally on a computer, remotely on a cloud, or the like. In some exemplary embodiments, the runtime data may comprise information about the variables, functions, and objects in the program, including their names, types, memory locations, execution statistics, metadata, or the like.

In some exemplary embodiments, depending on the specific design and architecture of the JIT engine and the runtime environment, the runtime data may be retained on various memory structures. In some cases, runtime data may be retained within a symbol table, embedded within the program code or any other intermediate representation, within dynamic data structures retained in the heap memory, incorporated into tagged pointers, or the like.

One technical problem dealt with by the disclosed subject matter is to leverage data from a memory of a JIT engine, without necessarily being provided with access thereto by the JIT engine, and without affecting the execution. For example, some JIT engines may not provide an Application Programming Interface (API) to access their memory, making it challenging to access the retained data for tracking the function calls. As another example, some naïve methods to extract data from a JIT engine may adversely affect the program's execution. For example, such naïve methods may include injecting a hooking library into the JIT engine's process space, enabling instrumentation or debugging flags within the process of the JIT engine, or the like, which may slow down the execution, increase the resource consumption of memory and computational power, distort the JIT compilation, introduce errors, require frequent sampling and/or polling, or the like.

One technical solution of the disclosed subject matter is utilizing a locally executed software agent that is external to the JIT process, to leverage the memory of JIT engines. In some exemplary embodiments, a software agent may be deployed on a client device, software cloud, server, execution platform, or the like, over which the JIT compilation process of the program may be performed. In some exemplary embodiments, the software agent may also be referred to as “data extractor”, “software module”, or “sensor”.

In some exemplary embodiments, the software agent may be configured to extract and capture runtime data from a computing environment in which the JIT compilation process is performed. For example, the software agent may capture runtime data from a heap memory of the JIT engine, a stack memory, code cache, internal data structures, or the like. For example, the software agent may extract runtime data by accessing an in-process memory in use by the JIT framework during the program's execution.

In some exemplary embodiments, in runtime environments that do not provide access to the in-process storage of the JIT engines, the runtime data may be extracted by the software agent using one or more extraction or hacking techniques. For example, the runtime data may be extracted by assigning to the software agent high access privileges and/or access permissions. According to this example, the software agent may be assigned elevated privileges such as root, kernel, or administrator privileges, which may enable the software agent to attach to the runtime's process and directly access its in-process memory. As another example, the runtime data may be extracted using debugging tools, direct memory access tools, by exploiting one or more vulnerabilities of the runtime environment, or the like. As another example, the runtime data may be extracted by capturing a snapshot of the memory in the runtime environment through techniques such as memory dumping or side-channel scanning.

In some exemplary embodiments, in runtime environments that provide access to the in-process storage of the JIT engines, such as via an API, the software agent may utilize the API to extract the runtime data.

In some exemplary embodiments, by accessing one or more memory buffers of the JIT engine, such as a heap memory, a stack memory, code cache, internal data structures, dynamic data structures, intermediate representations of the program code, or any other memory in which the JIT compilation process may retain runtime data, the JIT compilation process may be leveraged to identify which code components are active and which code components are not.

In one scenario, the program may be executed by the JIT engine and relevant information may be retained in a Random Access Memory (RAM) of a runtime execution platform. The software agent may be executed on the same execution platform as the JIT engine, e.g., over a same computer. In some exemplary embodiments, during execution of the program, dynamically allocated data such as runtime data (e.g., variables, objects, function call data, or the like) may be retained in a heap memory region of the RAM. In some exemplary embodiments, the software agent may be configured to extract the runtime data from the heap and process the data. In some cases, the software agent may be enabled to access the heap due to having elevated privileges, using API calls, or the like.

In some exemplary embodiments, the runtime data retained at the in-process memory of the JIT engine, such as its heap memory region, may dynamically change between program executions, and/or within a single program execution. In some cases, the JIT engine may retain runtime data of a certain time window or portion of the process at the in-process memory, without necessarily accumulating the runtime data over an entire process. For example, the heap memory region may retain an indication of a function execution during a first part of a program execution, and not during a second part of the program execution. In some cases, different executions of a program may result with different runtime values retained at the in-process memory. For example, the runtime data may differ for different configurations, parameters, input values, or the like, which may be provided to or configured for different executions of a program.

In some exemplary embodiments, instead of relying on a single content of the heap at a single point in time, as obtained from a single program execution, the software agent may accumulate the contents of the heap over a plurality of program executions, over a plurality of time segments during a single program execution, or the like. In some exemplary embodiments, every program execution may be performed using different program configurations, parameters, input values, or the like, such as in order to obtain a full coverage of the active code areas of the program. In some exemplary embodiments, the program may be executed iteratively using the JIT engine, and the runtime data of the executions may be extracted by the software agent, accumulated and stored. For example, the software agent may iteratively obtain runtime data and forward it to an accumulating module such as a server. As another example, the software agent itself may obtain and accumulate the runtime data over time.

In some exemplary embodiments, the runtime data may be accumulated after each execution, during one or more points in time during a single execution, or the like. For example, a plurality of program executions may be performed over time, and runtime data may be captured from the in-process memory after each JIT compilation of a program. As another example, runtime data may be periodically captured from the in-process memory of a single program execution every defined number of milliseconds (ms), every defined event such as every critical event, continuously, or the like. In some exemplary embodiments, data indicative of a number of times that each code unit was executed by the JIT framework during the capturing of the runtime data, may be extracted.

For example, a code unit of the program may be invoked only in certain conditions, such as when the program is initialized with certain values. In such cases, it may be difficult to identify that the code unit is active. For example, in order to identify its activity, the program may be executed a plurality of times, using a plurality of values, and the runtime data of the plurality of executions may be accumulated and stored. As long as at least one of the executions caused the code unit to be executed, the code unit may be identified as an active code unit.

In some exemplary embodiments, the captured runtime data from the in-process memory may be accumulated and processed, to determine the activity status of each code unit of the program. In some exemplary embodiments, the captured runtime data may be used to assess the activity status of code units in practice, e.g., whether they are inactive or active in the execution. For example, the activity status of a code unit may be determined according to the actual runtime usage of the code unit, as it was actually executed by the JIT engine. As opposed to theoretical activity estimation of code units, the activity status inferred from the captured runtime data may reflect actual execution of code units during runtime.

In some exemplary embodiments, the captured runtime data may be leveraged to determine which code units of the program are executed. In some cases, the captured runtime data may be utilized to determine how frequently each code unit is executed within a sliding time window. In some cases, the captured runtime data may be utilized to determine a count of function calls. For example, the captured runtime data may be analyzed to determine the actual usage of functions, the frequency of function calls, the libraries containing these functions, the packages that include these functions, or the like.

In some exemplary embodiments, an analysis of accumulated runtime data may be performed, to extract therefrom runtime metrics (also referred to as “execution statistics”). In some exemplary embodiments, the in-process memory of the runtime environment may not necessarily state explicit runtime metrics such as function call counts. In some exemplary embodiments, the in-process memory may be processed to derive insights regarding the frequency of code unit executions. In other cases, runtime metrics may be stated explicitly in the in-process memory and extracted therefrom.

In some exemplary embodiments, accumulated runtime data may be processed. For example, the in-process memory of the runtime environment, such as the heap memory thereof, may store one or more instances of memory objects. In some exemplary embodiments, the memory objects within the heap may represent respective code units of the program, as they are being executed.

In some exemplary embodiments, a memory object in the heap may hold data relating to a code unit that it represents. For example, a memory object may hold data indicating a name of a function that it represents, the function's parameters and return type, the entry point of the function in the program's execution, pointers to the code instructions related to the function, data about the function's control flow, or the like. As another example, a memory object may hold data regarding a classification of a function or code unit as a hot spot or as a non-hot spot. According to this example, the classification of a memory object may comprise metadata used by the JIT framework to determine whether to compile the function and use a compiled machine code or whether to execute the function using an interpreter. As another example, a memory object may hold data regarding runtime metrics such as a call count, an execution time, an average execution time, the number of executions of each function, or the like. According to this example, the runtime metrics of a function may comprise execution statistics of the function, tracked by the JIT engine, during each execution of the program. For example, the execution statistics may be generated by the JIT engine during an execution of the program.

In some exemplary embodiments, while the runtime metrics and/or execution statistics of a code unit may be tracked by the JIT engine for its own purpose, e.g., to decide whether a function should be compiled into machine code by the JIT compiler, the runtime metrics may be used by the disclosed subject matter for its security vulnerability assessment. Specifically, the data may be utilized for classifying code units as active or inactive code, to reduce false positive alerts and reduce resource investment regarding inactive code units.

In some exemplary embodiments, data from memory objects may be extracted

and/or accumulated. A code unit that each object represents may be classified according to the data. For example, based on accumulated data from a memory object that represents a code unit, runtime metrics such as execution statistics of the code unit may be inferred, determined, or the like. As another example, runtime metrics of a code unit may be aggregated over different executions of a program, to a single runtime metric. For example, if a code unit was executed 3 times during a first execution, 4 times during a second execution, and 2 times during a third execution, the data may be aggregated to a single metric, such as a metric indicating an average number of executions of 3, a minimum number of executions of 2, an overall number of executions of 9, or the like.

In some exemplary embodiments, the runtime data of a code unit may be captured, extracted and/or aggregated across multiple program executions over one or more computers, execution platforms, or the like. In some cases, the runtime metrics of a code unit may be maintained for each execution individually, for all the executions collectively, or the like. In some exemplary embodiment, information from multiple executions may be aggregated to identify which functions are actually invoked during runtime of the program.

In some exemplary embodiments, the runtime metrics may identify at least a frequency of calls to code units such as functions. In some exemplary embodiments, in case a frequency of function calls to a function is above zero, as reflected by the runtime data, the function may be classified as active. In some exemplary embodiments, in case a frequency of function calls to a function is zero, the function may be classified as inactive. In some exemplary embodiments, code units such as packages, libraries and/or functions that are not called even once in the runtime data, may be classified as inactive code units. In some exemplary embodiments, the classification may be performed by the software agent, by a server, by a computing device, or the like.

In some exemplary embodiments, the classification of code units of a program may be generated and stored. In some exemplary embodiments, the classification of code units as active or inactive, may be used to generate and/or adjust a list of vulnerabilities of the program. For example, a list of CVEs may be adjusted accordingly. In some cases, the classification of code units may be stored as a use-profile (also referred to as a “runtime profile”) for each program, application, code component thereof, or the like, for which a vulnerability assessment is requested. In some cases, a use-profile may integrate the classification of code units with external data, such as instrumentation data, monitored call chains, captured events, or the like, in order to characterize the typical behavior that is expected of each code unit, such as whether or not it is active, and if it is active, which component is expected to call the code unit.

In some exemplary embodiments, the classification of code units may be utilized for determining and generating an enhanced security vulnerability assessment and presenting it to a user, e.g., to data security experts, cyber security software, or the like. In some exemplary embodiments, the enhanced security vulnerability assessment may inform users of threats that can be introduced through active code units of the program. In some exemplary embodiments, the enhanced security vulnerability assessment may be configured to prioritize security vulnerabilities of active code units over security vulnerabilities of inactive code units, such as by visually emphasizing security vulnerabilities of active code, not presenting security vulnerabilities of inactive code units, or the like. In some exemplary embodiments, the enhanced security vulnerability assessment may be generated as a report detailing security vulnerabilities, as a visual graph illustrating exposure paths, as a searchable interface that enables users to input a code unit as a query and determine whether it is classified as active, or the like.

In some cases, an initial security vulnerability assessment may be generated for the entire program (e.g., for active and inactive areas alike), such as by a third-party application. In some exemplary embodiments, the initial security vulnerability assessment may be agnostic to whether or not the vulnerable code unit is active or inactive. Additionally, or alternatively, the initial security vulnerability assessment may be based on a theoretical estimation regarding activity or inactivity of the code units (e.g., based on static analysis of the source code). In some exemplary embodiments, the initial security vulnerability assessment may comprise a list of CVEs or other security vulnerabilities that were matched to the program, to code units thereof, to libraries thereof, to packages thereof, or the like. For example, each open-source library of the program may be matched to published CVEs that were found for the library.

In some exemplary embodiments, the initial security vulnerability assessment may be converted to an enhanced security vulnerability assessment based on the determined classification of code units. In some exemplary embodiments, the enhanced security vulnerability assessment may be generated by filtering out from the initial security vulnerability assessment, security vulnerabilities of inactive libraries or packages that do not include any function that was executed during the program execution. In some exemplary embodiments, a library or package may be classified as active in case they comprise at least one function that is active, and as inactive in case all of its functions are inactive.

For example, the initial security vulnerability assessment may comprise a list of fifty CVEs of a program. According to this example, the list may be processed to filter out all the CVEs that relate to inactive code units. For example, this may result with three CVEs remaining in the list, thereby narrowing down the list of CVEs of the program and reducing the burden of the security teams. As another example, instead of removing CVEs of inactive code units, their risk scores may be reduced.

In some exemplary embodiments, instead of converting an initial security vulnerability assessment to an enhanced security vulnerability assessment, the enhanced security vulnerability assessment may be generated from scratch. For example, CVEs may be identified and determined only for active code units.

In some exemplary embodiments, the enhanced security vulnerability assessment, with a narrowed down CVE list, may be provided to one or more users. In some exemplary embodiments, the enhanced security vulnerability assessment may present to a user a list of vulnerabilities of active code units. For example, the enhanced security vulnerability assessment may exclusively present a list of security vulnerabilities of program components such as libraries, that include at least one function that was effectively and practically executed at least once. In some exemplary embodiments, the enhanced security vulnerability assessment may present to a user a list of security vulnerabilities, in which security vulnerabilities of active code units are prioritized over security vulnerabilities of inactive code units. For example, security vulnerabilities of inactive code units may be presented lower down the list, with reduced risk scores, with less salient visual effects, or the like.

In some exemplary embodiments, the enhanced security vulnerability assessment may enable security teams to focus on libraries and functions that are actually in use, filtering out irrelevant code, and narrowing down the scope for security vulnerability assessment.

In some exemplary embodiments, the enhanced security vulnerability assessment may or may not be generated to incorporate one or more responsive actions, suggestions, remediations, or the like. For example, the enhanced security vulnerability assessment may suggest to upgrade a package of the program in order to overcome a CVE of an active vulnerability.

In some exemplary embodiments, the classification of code units may be utilized for one or more objectives, in addition to or instead of generating the enhanced security vulnerability assessment. For example, the classification may be used for generating a use-profile of program components, representing the expected behavior of each code unit. According to this example, the use-profile may be used for detecting potential security breaches in real time, by identifying deviations from expected behavior, as defined by the classification of active and inactive code units.

In some exemplary embodiments, real time events of a program execution may be monitored via instrumentation techniques, and compared to their expected behavior as represented by the use-profile. For example, an invocation of a function call may be compared to the use-profile, to determine whether the function is classified as active or inactive. According to this example, in case the function is classified as inactive and is yet invoked to be executed, this may be determined as an anomaly that can potentially represent a threat. For example, such a scenario may indicate a security threat or an exploitation attempt.

One technical effect of utilizing the disclosed subject matter is to enable security teams to focus on security vulnerabilities of program libraries and functions that are active and thus relevant. In some exemplary embodiments, the disclosed subject matter is configured to provide enhanced security vulnerability assessments that enable to prioritize vulnerabilities of code units of a program that are actively used during executions of the program by a JIT engine. In some exemplary embodiments, prioritizing active code units over inactive code units enables to reduce the scope of security vulnerability assessments and the burden of security teams, as well as computational resources (e.g., processing resources, memory resources, or the like). In some exemplary embodiments, narrowing down the scope for security vulnerability assessment may reduce the attack surface that needs to be identified and addressed by the security teams, thereby reducing their burden.

For example, in case a program has a first CVE with a high-risk score, high urgency, or the like, but the disclosed subject matter identifies that the first CVE is related to inactive code, the security team may be enabled to ignore such CVE and focus on a less urgent second CVE that is associated with active code, and is in practice more important than the first CVE.

Another technical effect of utilizing the disclosed subject matter is improving resource utilization by filtering out security vulnerabilities of inactive code, which minimizes unnecessary computational overhead of the assessment. In some exemplary embodiments, by eliminating unnecessary analysis of inactive code, such as irrelevant or outdated code, the security vulnerability assessments may be performed using less resources. For example, security vulnerability assessments may be performed with reduced resource consumption. Security vulnerabilities of irrelevant and inactive code may be filtered out from the security vulnerability assessment, made less salient, or the like, and may not be processed at all or in part.

Yet another technical effect of utilizing the disclosed subject matter is improving the accuracy of vulnerability detection by focusing on critical, actively used parts of the code. In some exemplary embodiments, by focusing on functions and libraries that are executed during runtime, the disclosed subject matter provides enhanced evaluations of vulnerabilities that are quicker and more focused.

Yet another technical effect of utilizing the disclosed subject matter is leveraging a JIT engine to identify the active code units of the program, in a high-speed and lightweight manner. In some exemplary embodiments, the JIT engine may be leveraged by capturing runtime data from an in-process memory region of the JIT engine, and inferring activity or inactivity classification based thereon.

In some exemplary embodiments, leveraging the JIT engine may be more efficient and lightweight compared to other monitoring solutions that monitor program executions. For example, monitoring functions that use Berkeley Packet Filters (eBPF), Kernel Runtime Security Instrumentation (KRSI), or the like, may attach monitoring functions to code running in containers in order to track function calls, system calls, and other behaviors of the program's execution. These methods often require high sampling rates and generate large volumes of data, while not necessarily improving the accuracy of the data. In contrast, the disclosed subject matter samples the in-process memory of the JIT engine at a significantly reduced rate and overhead, focusing on critical events, which may lead to more efficient monitoring of active code units.

Yet another technical effect of utilizing the disclosed subject matter is enabling to enrich a use-profile of a program with a classification of code units as active or inactive, using reduced resources. For example, the classification of code units as active or inactive, as performed by the disclosed subject matter, is based on a low sampling rate of the in-process memory of the JIT engine, while alternative classifications rely on continuous and/or high-rate data sampling of events and function calls, such as using low efficiency and highly intrusive instrumentation methods.

In some exemplary embodiments, the use-profile may be used for detecting in real time potential security breaches, such as deviations in expected function execution patterns, which could indicate a live exploitation attempt. In some exemplary embodiments, potential security breaches may be detected by monitoring deviations from expected behavior, as defined by the classification of active and inactive code units.

The disclosed subject matter may provide for one or more technical improvements over any pre-existing technique and any technique that has previously become routine or conventional in the art. Additional technical problem, solution and effects may be apparent to a person of ordinary skill in the art in view of the present disclosure.

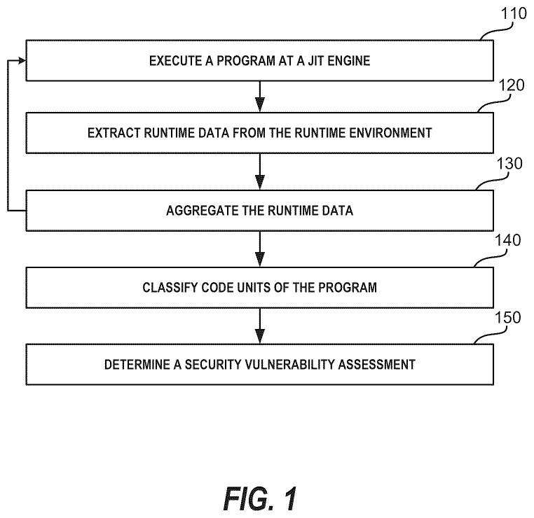

Referring now to FIG. 1 showing a flowchart diagram of a method, in accordance with some exemplary embodiments of the disclosed subject matter.

On Step 110, a program may be executed by a JIT engine within a runtime environment, e.g., in order to enhance a vulnerability assessment. In some exemplary embodiments, the JIT engine may be configured to execute the program without a-priori compiling the program. In some exemplary embodiments, the JIT engine may be configured to retain runtime data of the program's execution at an in-process memory, e.g., in a heap. For example, the JIT engine may be configured to compile portions of the program such as hot spots, based on the runtime data.

On Step 120, the runtime data of the program execution may be extracted from the runtime environment. For example, the runtime data may be extracted from the in-process memory. In some exemplary embodiments, the runtime data may be extracted by a software agent that is external to the process of the JIT engine, external to the JIT engine, external to a runtime environment in which the execution of the program is performed, or the like. For example, the software agent may comprise a desktop agent, a web-based agent, a browser extension, or the like.

In some exemplary embodiments, in order to extract the runtime data from a runtime environment that lacks APIs, high access privileges may be assigned to the software agent. For example, root or administrator privileges in an Operating System (OS) of a host computer used to execute the program, may be assigned to the software agent. In some exemplary embodiments, the high access privileges may be utilized to attach the software agent to a runtime process of the JIT engine, e.g., the process that performs the execution of the program. In some exemplary embodiments, the software agent may directly access the in-process memory via the process. In some exemplary embodiments, the software agent may extract the runtime data by capturing a snapshot of the memory in the runtime environment through techniques such as memory dumping or side-channel scanning. In some exemplary embodiments, a memory snapshot may be gathered using a hypervisor-level memory dump, where memory is extracted directly from a virtual machine; using an OS-level memory dump, where the memory of a running process or the entire system is captured through system-level mechanisms; using a memory dump of a Virtual Machine (VM), where the full memory state of a VM is preserved and analyzed; or the like. Additionally, or alternatively, memory snapshots may be obtained externally to the OS through techniques such as Direct Memory Access (DMA), firmware-level extraction, hardware-based debugging interfaces, or the like. In some cases, instead of the software agent hacking the in-process memory, a personalized interpreter may be used that is configured to provide all runtime data to the software agent. In other cases, such as in case the in-process memory has an API, is accessible, or the like, the runtime data may be extracted from the in-process memory directly.

In some exemplary embodiments, the runtime data may be captured and/or extracted from the in-process memory continuously, periodically (e.g., every two minutes, ten minutes, or the like), upon a predefined event such as a critical event, every execution of a program, or the like. In some cases, the runtime data may be extracted upon a predefined event, such as upon execution of the program, upon invocation of the JIT framework to execute the program, or the like. For example, the software agent may monitor a user's computing device to determine whether the program is being executed. As another example, the frequency of capturing the runtime data may be defined or set by a user, a programmer of the JIT framework, by default settings, according to instructions from a remote entity, or the like. In some cases, the runtime data may be captured during a time period in which two or more programs are executed by the JIT framework, separately, sequentially, in parallel, with some overlapping times, or the like.

As another example, the interpreter of the JIT framework may be replaced by an embedded or hooked script that launches the software agent upon execution of the program by the JIT engine.

In some exemplary embodiments, the runtime data may comprise execution statistics, tracking how often code units such as functions or code segments are executed in practice per time unit, an overall count of code unit executions, or the like. For example, the execution statistics may be retained by the profiler of the JIT engine, when searching for hot spots. In some exemplary embodiments, the execution statistics may comprise one or more call counts that track function execution frequency, the number of times the function was invoked and/or executed, or the like, during the execution of the program by the JIT framework.

In some exemplary embodiments, the runtime data may reflect dynamic behavior, capturing branching, loops, and conditional paths followed during execution, e.g., as may be retained by the profiler of the JIT engine. In some exemplary embodiments, the runtime data may comprise optimization metrics such as instruction counts, cache usage, and execution timings, e.g., as may be retained by the profiler. In some exemplary embodiments, the runtime data may comprise metadata regarding functions or code elements, such as their names, memory locations, and dependencies, e.g., as retained in the symbol table. In some exemplary embodiments, the runtime data may comprise memory usage information, such as heap or stack allocations tied to JIT-compiled code, e.g., as may be retained by the garbage collector or any other memory manager. In some exemplary embodiments, the runtime data may comprise data regarding compilation decisions, indicating which code parts were compiled into machine code and the type of optimizations applied thereto, e.g., as retained by the JIT compiler.

On Step 130, the runtime data may be aggregated over a plurality of executions of the program. For example, Steps 110-130 may be performed iteratively, each time executing the program using different parameters, configurations, settings, values, or the like. For example, fuzz testing may be performed. In some exemplary embodiments, after and/or during each execution, runtime data may be extracted from the in-process memory on Step 120 and aggregated with previous runtime data on Step 130.

In some exemplary embodiments, runtime data that is extracted from the in-process memory may be aggregated with previously extracted runtime data of the program, thereby obtaining aggregated runtime data. For example, while an initial execution of the program may retain runtime data associated with the interpreter's execution of the program, a subsequent initial execution of the program may retain runtime data associated with at least some machine code generated for hot spots. In some exemplary embodiments, the previously extracted runtime data may be extracted by the software agent based on previous executions of the program, based on previous executions of portions of the program, or the like.

In some exemplary embodiments, the aggregated runtime data may be processed or analyzed to generate runtime metrics, such as a function call count, a function execution time, an average execution time of a function, a number of executions of each function, deviations between function call counts in different executions, or the like. In some exemplary embodiments, Steps 110-130 may be performed iteratively until a sufficient volume of data is accumulated, until one or more conditions are complied with, or the like. For example, Steps 110-130 may be performed iteratively until a coverage estimation indicates that the coverage of the executions complies with a threshold. For example, one or more code coverage metrics may be used to estimate the coverage.

On Step 140, code units of the program may be classified based on the extracted runtime data, based on the aggregated runtime data, or the like. For example, the aggregated runtime data may be processed and/or analyzed to determine a classification for each code unit.

In some exemplary embodiments, code units of the program may be classified as active code units or as inactive code units. In some exemplary embodiments, a code unit may be classified to be active in case it includes at least one function that is indicated by the runtime data as being executed at least once. For example, if during one of the iterative program executions of Step 110, a code unit was executed (e.g., when using a specific parameter value as input to the program), and during all the other program executions the code unit was not executed, the code unit may be classified as active. In some exemplary embodiments, a code unit may be classified to be inactive in case it is absent of any function that is indicated by the runtime data as being executed at least once, during at least program execution. For example, a function with a call count of “1”, “2”, or “2,000” may be classified as active, while another function with a call count of “0” during all the program executions may be classified as inactive.

In some exemplary embodiments, the code units may be classified according to a granularity level of the vulnerability assessment (also referred to as “micro-segmentation”). In some exemplary embodiments, the granularity level may comprise a function granularity level, a library granularity level, a package granularity level, or the like. For example, in case the vulnerability assessment of the program is provided in the function granularity level, functions may be classified as active or inactive. As another example, in case the vulnerability assessment of the program is provided in the library granularity level, libraries may be classified as active or inactive. As another example, in case the vulnerability assessment of the program is provided in the package granularity level, packages may be classified as active or inactive. In other cases, classifications may be performed for multiple granularity levels, e.g., for all. In some exemplary embodiments, the granularity level may comprise any other granularity levels, e.g., granularity levels of modules, interfaces, classes, sets of one or more methods, sets of one or more functions, or any other computer program artifacts or portion thereof.

On Step 150, based on the classification of the code units of the program, a security vulnerability assessment of the program may be determined. In some exemplary embodiments, the security vulnerability assessment may be generated as a report detailing security vulnerabilities, as a searchable interface that enables users to input a code unit identifier or name as a query to determine whether it is classified as active, or the like. In some exemplary embodiments, the security vulnerability assessment may comprise prioritizing first vulnerabilities that are associated with the active code units over second vulnerabilities of the inactive code units.

In some exemplary embodiments, the security vulnerability assessment may or may not be presented on a screen, such as to a user. In some exemplary embodiments, a user interface presentation for a vulnerability assessment of the program may be generated. In some exemplary embodiments, the user interface presentation may be generated by prioritizing a display of first vulnerabilities of the active code units over a display of second vulnerabilities of the inactive code units.

In some exemplary embodiments, the first vulnerabilities of the active code units may be prioritized over the second vulnerabilities of the inactive code units by removing the second vulnerabilities from the user interface presentation, by retaining the second vulnerabilities in the user interface presentation while reducing their risk scores, by visually emphasizing the first vulnerabilities of the active code units, or the like.

For example, a third-party application may generate an initial vulnerability assessment to comprise a list of vulnerabilities, e.g., a list of CVEs, corresponding risk scores, or the like, all of which match the program. According to this example, the user interface presentation may be generated by adjusting the list of vulnerabilities units to remove the second vulnerabilities from the user interface presentation, to reduce a risk score of the second vulnerabilities in the user interface presentation, or the like.

As another example, the vulnerability assessment may be generated from scratch according to the classification of code units. For example, the vulnerability assessment may be generated to incorporate vulnerabilities of the active code units, and not to incorporate vulnerabilities of inactive code units.

In some exemplary embodiments, the vulnerability assessment may or may not suggest one or more responsive actions such as remediations to listed vulnerabilities. For example, responsive actions may comprise upgrading a package for which a vulnerability is listed, preventing certain operations such as system calls, alerting users such as via notifications, or the like.

In some cases, the classification of code units may be utilized for one or more additional tasks, objectives, or the like. For example, the classification of code units may be utilized for generating a use-profile of the program, of components thereof, or the like. In some cases, the use-profile may be generated based on the classification, the aggregated runtime data of the program, additional data, or the like. In some cases, the use-profile may be generated based on additional data, such as instrumentation data, monitored call chains, captured events, or the like, which may be monitored using instrumentation techniques such as eBPF. For example, the use-profile may be created after accumulating a sufficiently large volume of data as defined by a user, a threshold, a rule, a constraint, or the like, over a sufficiently long timeframe, e.g., a month, year, or the like.

In some exemplary embodiments, the use-profile may be generated to indicate, for code units of the program in one or more granularity levels, an expected behavior of the code unit. For example, in case a code unit is a hot spot, the expected behavior of the program may be to execute the code unit frequently, while in case a code unit is inactive for over a year, the expected behavior of the program may be to not execute the code unit at all. In some exemplary embodiments, the use-profile may be generated to indicate any other data, execution statistics, or the like, such as the expected call chain of a code unit, an expected functionality of the code unit, or the like.

In some exemplary embodiments, the use-profile may be used to estimate in real time whether code units of the program act according to their expected behavior in real time executions, enabling to swiftly and efficiently respond to identified threats. In some exemplary embodiments, real time events of a program execution may be monitored, e.g., using instrumentation such as eBPF and KRSI or any other technique, and compared to the expected behavior, as indicated by the runtime profile. In some exemplary embodiments, the comparison of the expected behavior may be performed against real time events of the program execution.

For example, monitoring functions such as eBPF may be utilized to monitor real time events of the program, functionalities thereof, call chains thereof, or the like, as disclosed in patent application Ser. No. 18/755,280, entitled “PROACTIVE DYNAMIC RUNTIME COMPUTER CODE MONITORING” filed Jun. 26, 2024, referred to as the “proactive monitoring method”, which is hereby incorporated by reference in its entirety without giving rise to disavowment. For example, the proactive monitoring method may be used to track an “attack surface” indicating which functions are called, which code units are executed, which code unit called each function, which system calls are made, which code units invoke each system call, or the like. According to this example, the monitored activities may be compared to the use-profile, to determine whether each activity was expected to be performed, whether the activity was invoked by the expected code unit, whether each type of system call is invoked by the expected code units, or the like. In other cases, real time events may be monitored in any other way.

In some exemplary embodiments, the comparison between monitored activities and the use-profile may be used to identify anomalies, deviations, or the like, of the program execution flow in real time. For example, deviations from the expected behavior may represent a threat, a risk, an attack, or the like, such as a potential live exploitation attempt by an attacker. For example, a deviation may include an execution of inactive code, calling active code in violation of the call chain, executing atypical OS operations, or the like. For example, in case the monitored activities indicate that a system call is being invoked, the use-profile may be used to determine whether the system call is expected or not, whether the system call is invoked in an expected manner, or the like. In case the system call is not expected, a deviation may be identified. As another example, in case the monitored activities indicate that a function is called, and the function is classified as an inactive function by the use-profile, a deviation may be identified.

In some exemplary embodiments, in case of detected deviations, one or more responsive actions may be performed, triggered, or the like. For example, responsive actions may comprise blocking a deviation in real time, blocking an unexpected system call, terminating the program execution, preventing unexpected operations, alerting users such as via notifications sent to their end device, logging the deviation for further analysis, displaying the results on a dashboard for easy visualization and investigation, or the like. For example, the responsive actions may be performed by the software agent.

In some exemplary embodiments, integrating the classification of code units into the use-profile, as facilitated by the disclosed subject matter, may optimize the time and computational resource consumption of the use-profile generation process. For example, without the disclosed subject matter, classifying the status of a code unit as active or inactive for the use-profile (e.g., to predict whether the code unit will be executed) would require high-frequency sampling across multiple program executions to capture all code activity. Simply tracking system call invocations would not suffice, as all function calls and executions must be monitored for accurate classification. For example, the proactive monitoring method would need to continuously sample events and function calls at a high rate, in order to identify the activity status of code units, leading to significant resource consumption.

In some exemplary embodiments, the disclosed subject matter enables a more efficient activity classification, replacing the resource-intensive classification performed by the proactive monitoring method while maintaining the same level of accuracy. For example, instead of relying on high-frequency sampling of real time events, the disclosed approach achieves activity classification through low-frequency monitoring of the in-process memory of the JIT engine, significantly reducing computational overhead.

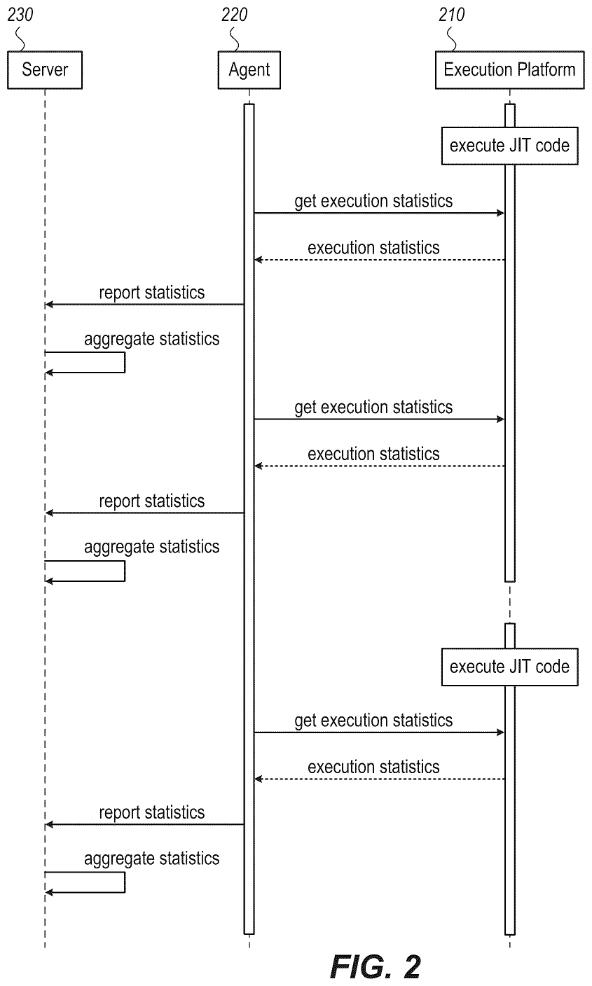

Referring now to FIG. 2 showing an exemplary sequence diagram, in accordance with some exemplary embodiments of the disclosed subject matter.

In some exemplary embodiments, as depicted in FIG. 2, a JIT engine within an Execution Platform 210 may be configured to execute a program. For example, the program may be denoted as “JIT code”. In some exemplary embodiments, Execution Platform 210 may comprise one or more execution platforms, e.g., cloud servers, cluster nodes, on-prem computers, end devices, user devices, servers, or the like, which may enable the JIT engine to execute one or more programs.

In some exemplary embodiments, a Software Agent 220 that is external to the JIT engine and the program may be executed, e.g., over Execution Platform 210, from remote, or the like. In some exemplary embodiments, Software Agent 220 may comprise a single agent, a plurality of agents, or the like. As an example, in case Execution Platform 210 comprises a plurality of platforms, a separate agent may be deployed in each platform.

In some exemplary embodiments, Software Agent 220 may capture the runtime data generated by the JIT engine, e.g., as it executes the program, after it executes the program, or the like. In some exemplary embodiments, the runtime data may comprise runtime metrics such as the number of times each code unit of the program was executed on Execution Platform 210 by the JIT engine, the frequency of code unit executions, or the like. For example, Software Agent 220 may process and/or extract data from an in-process memory of Execution Platform 210, to determine the runtime metrics.

In some exemplary embodiments, the JIT engine may execute the program a plurality of times, periodically, or the like. For example, the program may be configured to be executed every 100 milliseconds, 10 seconds, every 30 seconds, every minute, every 10 minutes, every adjustable period, or the like. In some exemplary embodiments, the JIT engine may repeatedly execute the program, each time applying different inputs, different configurations, or the like. For example, the program executions may constitute fuzz testing, real-time user interactions, deployment inputs, or the like.

In some exemplary embodiments, Software Agent 220 may report the runtime metrics to a server, e.g., Server 230. For example, every time the JIT engine executes the program, Software Agent 220 may report the corresponding runtime metrics to Server 230. In some exemplary embodiments, Server 230 may be deployed on Execution Platform 210, remotely therefrom, or the like. In some cases, Server 230 may be incorporated within Software Agent 220, or may be separate therefrom.

In some exemplary embodiments, Server 230 may accumulate reported runtime data from Software Agent 220. For example, the JIT engine may execute the program a plurality of time, and Software Agent 220 may capture runtime data during and/or after each execution and forward the data to Server 230. According to this example, Server 230 may accumulate the reported runtime data generated by the JIT engine during the plurality of executions.

In some exemplary embodiments, Server 230 may determine, based on accumulated reported runtime data, which code units are active, inactive, or the like, e.g., according to Step 140 of FIG. 1. For example, Server 230 may generate a use-profile for each program and/or program component according to its aggregated reported runtime data.

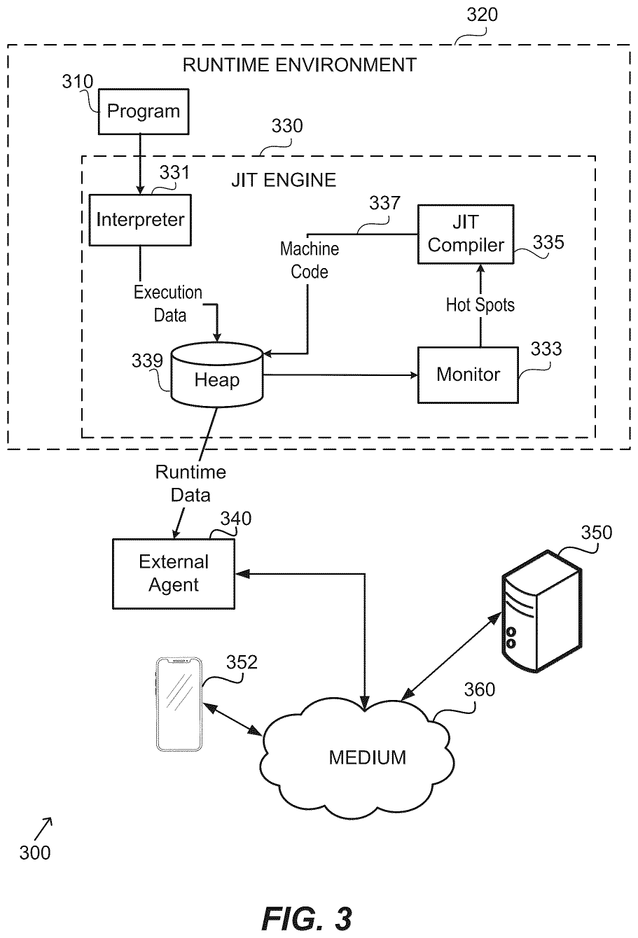

Referring now to FIG. 3 showing an exemplary environment in which the disclosed subject matter may be utilized, in accordance with some exemplary embodiments of the disclosed subject matter.

As depicted in FIG. 3, Environment 300 may comprise a Runtime Environment 320. In some exemplary embodiments, Runtime Environment 320 may comprise a Program 310, which may be scheduled to be inspected for vulnerabilities, and a JIT engine 330. In some cases, a vulnerability assessment may be already prepared for Program 310, and enhancement of the vulnerability assessment may be desired. In some cases, a vulnerability assessment may not be prepared for Program 310, and may be generated from scratch by the disclosed subject matter.

In some exemplary embodiments, Program 310 may be provided to Interpreter 331 of JIT engine 330. In some exemplary embodiments, Program 310 may be provided line by line or statement by statement to Interpreter 331. In some cases, the code portions provided to Interpreter 331 may be provided in the form of bytecode, source code, or the like.

In some exemplary embodiments, Interpreter 331 may process and execute instructions of Program 310, line by line or statement by statement, without converting them into machine code. In some exemplary embodiments, Interpreter 331 may utilize an in-process memory to retain dynamic and static execution data. For example, Interpreter 331 may utilize a Heap 339 to retain execution data within the process.

In some exemplary embodiments, while Interpreter 331 executes program instructions of Program 310, one or more modules of JIT engine 330 may monitor and/or analyze the execution. In some exemplary embodiments, Monitor Module 333 (e.g., also referred to as the “profiler” component) may analyze the execution data of Program 310, e.g., via Heap 339, to identify hot spots. For example, Monitor Module 333 may collect performance data regarding the memory usage of the execution of Program 310, the CPU usage, errors, hot spots of the program, or the like, such as while Program 310 executes. In some exemplary embodiments, Monitor Module 333 may forward any identified hot spots to a compiler of JIT engine 330, e.g., to JIT Compiler 335.

In some exemplary embodiments, JIT Compiler 335 may compile hot spots into machine-specific code. For example, JIT Compiler 335 may compile code units of Program 310 identified as hot spots, such as functions, into Machine Code 337 that matches the processor of the underlying execution platform. In some exemplary embodiments, Machine Code 337 may be retained at an in-process memory, such as in Heap 339.

In some exemplary embodiments, upon subsequent calls of functions identified as hot spots, within the execution of Program 310, the hot spots may not be processed by Interpreter 331, and instead a respective portion of Machine Code 337 may be executed. For example, Machine Code 337 may be fetched from Heap 339 and executed.

In some exemplary embodiments, JIT engine 330 may comprise one or more additional components (not depicted). For example, JIT engine 330 may comprise a “garbage collector” component that is configured to be executed in the background, keeping track of objects and memory that are no longer needed by the program and cleaning up the heap memory from unused objects. As another example, JIT engine 330 may comprise an “optimization passes” component, also referred to as an “Optimizing Compiler”, which may be configured to be executed in the background and to refine compiled machine code such as Machine Code 337. For example, the optimization passes may optimize Machine Code 337 to reduce its CPU cycles, such as by rearranging its code for better CPU cache efficiency.

In some exemplary embodiments, an external software agent, e.g., External Agent 340, which may be external to JIT engine 330, may be executed. In some cases, as depicted in FIG. 3, External Agent 340 may be external to both Runtime Environment 320 and JIT engine 330. In some cases, External Agent 340 may be internal to Runtime Environment 320 and external to JIT engine 330 (not depicted). In some cases, External Agent 340 may be configured to configure the multiple executions of Program 310, such as by providing different inputs thereto every execution. In other cases, the executions of Program 310 may be configured by any other component external to JIT engine 330, e.g., user interactions, deployment inputs, or the like.

In some exemplary embodiments, External Agent 340 may be configured to extract runtime data from Heap 339. For example, External Agent 340 may extract runtime data from Heap 339 during code executions, after each execution of Program 310, in response to critical events, or the like. In some exemplary embodiments, External Agent 340 may report extracted runtime data to a server, e.g., Server 350, such as via a communication medium such as Medium 360. In other cases, Server 350 may be implemented locally, such as by External Agent 340 or any other local component of Runtime Environment 320.

In some exemplary embodiments, Medium 360 may comprise a communication channel, such as a wired communication channel, a wireless communication channel, or the like. For example, Medium 360 may comprise a network, such as a Local Area Network (LAN), Wide Area Network (WAN), intranet, the Internet, a cellular network, or the like.

In some exemplary embodiments, Server 350 may be configured to store and aggregate runtime data obtained from External Agent 340, and determine a classification of code units of Program 310 into active code, inactive code, or the like. For example, in case a code unit was called or executed during one or more program executions, the code unit may be classified as active, and vice versa. In some exemplary embodiments, Server 350 may be configured to generate or adjust a vulnerability assessment of Program 310 based on the classification. For example, an end device of a user, such as End Device 352, may present a list of CVEs of the Program 310.

In some exemplary embodiments, Server 350 may instruct End Device 352 to adjust the list based on the classification. For example, Server 350 may instruct End Device 352 via Medium 360 to remove CVEs of inactive code units, of libraries in which all functions are inactive, of packages in which all components are inactive, or the like. As another example, Server 350 may instruct End Device 352 via Medium 360 to reduce a risk score or a saliency level of CVEs of inactive code units, of libraries in which all functions are inactive, of packages in which all components are inactive, or the like. As another example, Server 350 may instruct End Device 352 to visually emphasize CVEs of active code, such as by making them more salient than the CVEs of inactive code.

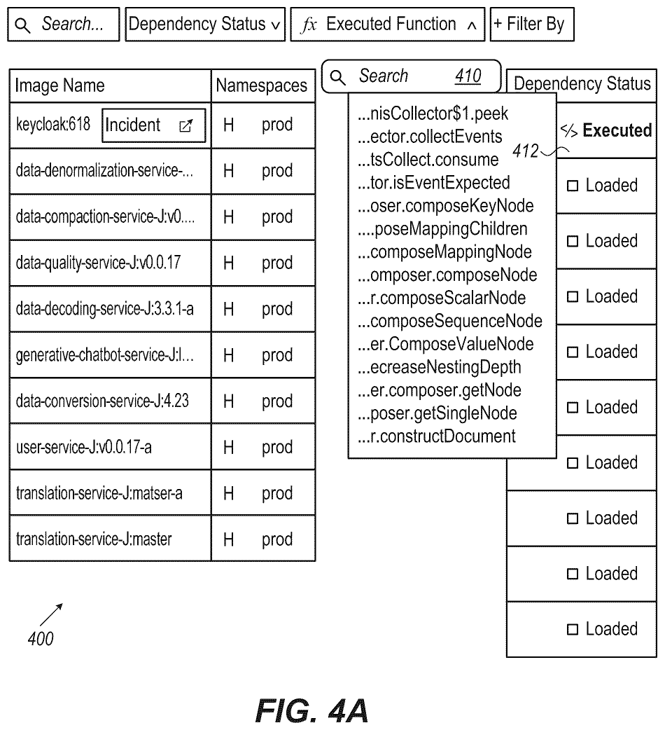

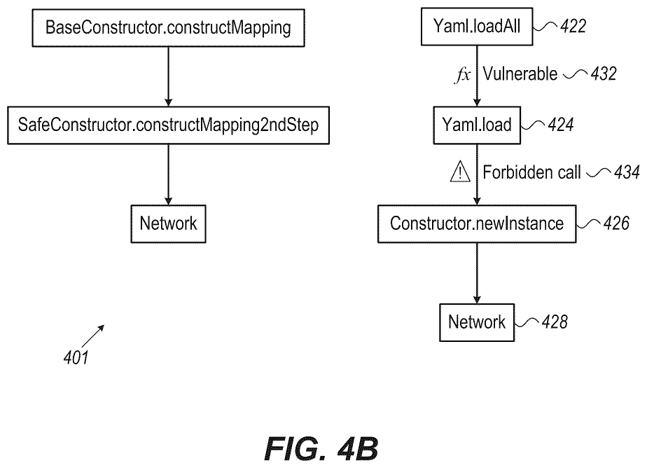

Referring now to FIGS. 4A-4B showing exemplary displays of security vulnerability assessments, in accordance with some exemplary embodiments of the disclosed subject matter.

As depicted in FIG. 4A, a dashboard or monitoring tool may be used to display a generated security vulnerability assessment, e.g., Assessment 400, to a user. In some exemplary embodiments, Assessment 400 may comprise a searchable interface that enables users to input a code unit identifier such as a function name as a query, and to obtain in response a classification of the code unit as active or inactive. In some exemplary embodiments, Assessment 400 may comprise a search bar such as Search Bar 410, allowing users to search for a code unit. For example, the search may be a global search over all the code units of a program, a local search within a specific package of the program, or the like. In some cases, Search Bar 410 may present a list of suggested function names (e.g., from a recently updated package), as a dropdown menu.

As depicted in FIG. 4A, Assessment 400 may depict, for an image name representing a containerized service, a list of functions associated with that service and their status as active or inactive. For example, the “Dependency Status” column may indicate whether the service or a function thereof was executed (412), meaning it was actively run, or merely loaded without active execution.

As depicted in FIG. 4B, a generated security vulnerability assessment may be represented to users as a graph such as Graph 401. In some exemplary embodiments, Graph 401 may be generated to represent an “attack surface” indicating runtime activity (e.g., which functions are called, which system calls are made, or the like) and potential exposure paths.

In some exemplary embodiments, the classification of code units as active or inactive, as performed by the disclosed subject matter, may be used to generate a runtime profile of the program (e.g., on Step 140 of FIG. 1), and Graph 401 may be generated by correlating the runtime profile with real time events of a program execution. In some exemplary embodiments, the real time events may be monitored, e.g., using instrumentation such as eBPF or KRSI, the proactive monitoring method, or any other technique.

In some exemplary embodiments, the real time events may be compared to the expected behavior, as indicated by the runtime profile. In some exemplary embodiments, Graph 401 may depict whether code units of the program acted according to their expected behavior in real time executions. In some exemplary embodiments, Graph 401 may depict real time events of a program execution, such as function executions and calls (422, 424, 426), network events (428), or the like, as well as whether or not the events constitute deviations from the expected behavior represented in the runtime profile. For example, deviations from the expected behavior may comprise a threat, such as calling a vulnerable function (432), or making a forbidden call (434). For example, a forbidden call may comprise a function call of an inactive function, which is expected to be inactive according to the runtime profile.

In other cases, the security vulnerability assessment may be presented in any other way, e.g., as a report.

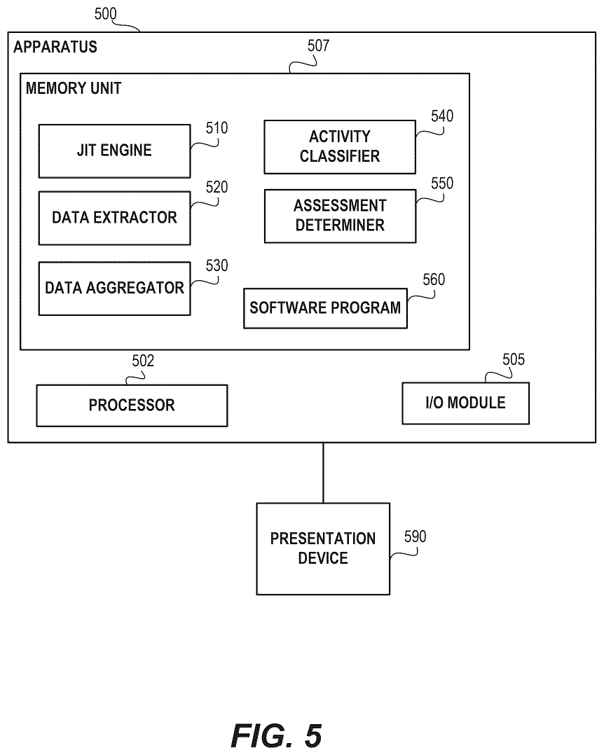

Referring now to FIG. 5 showing a block diagram of an apparatus, in accordance with some exemplary embodiments of the disclosed subject matter.

In some exemplary embodiments, an Apparatus 500 may comprise a Processor 502. Processor 502 may be a Central Processing Unit (CPU), a microprocessor, an electronic circuit, an Integrated Circuit (IC) or the like. Processor 502 may be utilized to perform computations required by Apparatus 500 or any of its subcomponents. Processor 502 may be configured to execute computer-programs useful in performing the methods of FIG. 1, or the like.

In some exemplary embodiments of the disclosed subject matter, an Input/Output (I/O) Module 505 may be utilized to provide an output to and receive input from a user. I/O Module 505 may be used to transmit and receive information to and from the user or any other apparatus, e.g., a plurality of user devices, servers, or the like, in communication therewith.

In some exemplary embodiments, Apparatus 500 may comprise a Memory Unit 507. Memory Unit 507 may be a short-term storage device or long-term storage device. Memory Unit 507 may be a persistent storage or volatile storage. Memory Unit 507 may be a disk drive, a Flash disk, a Random Access Memory (RAM), a memory chip, or the like. In some exemplary embodiments, Memory Unit 507 may retain program code operative to cause Processor 502 to perform acts associated with any of the subcomponents of Apparatus 500. In some exemplary embodiments, Memory Unit 507 may retain program code operative to cause Processor 502 to perform acts associated with any of the steps in FIG. 1, or the like.

In some exemplary embodiments, Memory Unit 507 may retain a program for which a vulnerability assessment is desired. For example, the program may comprise Software Program 560. In some exemplary embodiments, Software Program 560 may comprise a plurality of libraries (e.g., open-source libraries), functions, packages, or the like.

The components detailed below may be implemented as one or more sets of interrelated computer instructions, executed for example by Processor 502 or by another processor. The components may be arranged as one or more executable files, dynamic libraries, static libraries, methods, functions, services, or the like, programmed in any programming language and under any computing environment.

In some exemplary embodiments, JIT Engine 510 may be configured to obtain instructions of Software Program 560, line by line or statement by statement, and execute the instructions. In some exemplary embodiments, JIT Engine 510 may execute obtained code, such as bytecode, without converting it into machine code (e.g., through an interpreter), and execute hot spots of the Software Program 560 as machine code. In some exemplary embodiments, JIT Engine 510 may obtain the instructions via I/O Module 505 or via any other component or device.

In some exemplary embodiments, Data Extractor 520 may be configured to extract runtime data, which may be retained by the JIT Engine 510 during the execution of Software Program 560. In some exemplary embodiments, Data Extractor 520 may extract the data during the execution, after an execution is completed, or the like. In some exemplary embodiments, Data Extractor 520 may extract the data from an in-process memory used by JIT Engine 510, or any other memory buffer used by JIT Engine 510 for retaining execution-related data. In some exemplary embodiments, Data Extractor 520 may provide the obtained runtime data to Data Aggregator 530.

In some exemplary embodiments, JIT Engine 510 may execute instructions of Software Program 560 a plurality of times, such as using different parameters, input values, or the like. In some exemplary embodiments, Data Extractor 520 may extract runtime data from each execution of Software Program 560.

In some exemplary embodiments, Data Aggregator 530 may be configured to obtain and store runtime data that is extracted by Data Extractor 520 from each execution of Software Program 560. In some exemplary embodiments, Data Aggregator 530 may process and/or aggregate the stored runtime data from Data Extractor 520. In some exemplary embodiments, Data Aggregator 530 may aggregate a call count for each code unit over the plurality of executions, such that the aggregated call count of a code unit represents all the executions of the code unit over all the executions of Software Program 560.

For example, Data Aggregator 530 may determine a number of times each function of Software Program 560 is called over all the executions of Software Program 560, a number of times each library of Software Program 560 is executed, a number of times each package of Software Program 560 is executed, averaged execution statistics, a frequency of code unit executions per defined time window, or the like. In some exemplary embodiments, Data Aggregator 530 may provide the determined counts and/or numbers to Activity Classifier 540.

In some exemplary embodiments, Activity Classifier 540 may classify code units as active or inactive, e.g., based on an overall count of their calls or executions. In some exemplary embodiments, any code unit that has an aggregated call count (over the plurality of executions of Software Program 560) that is greater than zero, may be classified as active. In some exemplary embodiments, a code unit that has an aggregated call count (over the plurality of executions of Software Program 560) of zero, may be classified as inactive.

In some exemplary embodiments, Activity Classifier 540 may classify code units in one or more defined levels of granularity, as active code or inactive code. For example, Activity Classifier 540 may classify functions as active or inactive functions (e.g., in a first level of granularity). According to this example, a function may be classified as inactive in case it was not called even once, e.g., according to the count of function calls by Data Aggregator 530. As another example, Activity Classifier 540 may classify libraries as active or inactive libraries (e.g., in a second level of granularity). According to this example, a library may be classified as inactive in case none of its functions were called even once, e.g., according to the count of function calls by Data Aggregator 530. As another example, Activity Classifier 540 may classify packages as active or inactive packages (e.g., in a third level of granularity). According to this example, a package may be classified as inactive in case none of its libraries were called even once, e.g., according to the count of library executions by Data Aggregator 530.

In some exemplary embodiments, Activity Classifier 540 may classify code units according to a level of granularity of a vulnerability assessment of Software Program 560. For example, in case a vulnerability assessment of Software Program 560 is designed to present a list of CVEs for its libraries, the granularity level of Activity Classifier 540 may be configured to correspond to the individual library level. This configuration can also be applied to function and package levels.

In some exemplary embodiments, Assessment Determiner 550 may obtain code classifications from Activity Classifier 540, and determine a security vulnerability assessment based thereon. For example, Assessment Determiner 550 may adjust or generate a user interface of an end device, such as a graphical user interface (GUI) of Presentation Device 590, and present the assessment thereon. In some exemplary embodiments, Presentation Device 590 may be internal or external to Apparatus 500, and may comprise a screen that enables to present results of a vulnerability assessment, such as a list of vulnerabilities.

For example, Presentation Device 590 may present a list of vulnerabilities, or CVEs, of Software Program 560, in a certain level of granularity. According to this example, Assessment Determiner 550 may adjust the presentation of the list of vulnerabilities, such as to remove entries that are classified as inactive, to reduce a score of entries that are classified as inactive, or the like. As another example, Assessment Determiner 550 may generate the list of vulnerabilities only for active code units, without adjusting an existing list.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
executing a program by a Just-in-Time (JIT) engine in a runtime environment, the JIT engine is configured to execute the program without a-priori compiling the program, the JIT engine is configured to store runtime data of an execution of the program at an in-process memory, the JIT engine is configured to compile portions of the program based on the runtime data;
extracting, by a software agent that is external to a process of the JIT engine, the runtime data from the in-process memory;
based on the runtime data, performing a classification of code units of the program as active code units or inactive code units, wherein each of the active code units comprise at least one function that is indicated by the runtime data as being executed at least once, wherein each of the inactive code units is absent of any function that is indicated by the runtime data as being executed at least once; and
determining a security vulnerability assessment of the program, said determining is performed based on the classification of the code units of the program.

2. The method of claim 1 further comprising aggregating the runtime data that is extracted from said extracting, with previously extracted runtime data of the program, thereby obtaining aggregated runtime data,
wherein the previously extracted runtime data was extracted by the software agent based on previous executions of the program, and
wherein the classification is performed based on the aggregated runtime data.

3. The method of claim 2 further comprising processing the aggregated runtime data to generate runtime metrics, the runtime metrics comprise at least one of: a function call count, a function execution time, an average execution time of a function, or a number of executions of the function.

4. The method of claim 1, wherein said determining the security vulnerability assessment comprises prioritizing first vulnerabilities that are associated with the active code units over second vulnerabilities of the inactive code units.

5. The method of claim 4, wherein said prioritizing the first vulnerabilities comprises removing the second vulnerabilities of the inactive code from the security vulnerability assessment.

6. The method of claim 4, wherein said prioritizing the first vulnerabilities comprises reducing a risk score of the second vulnerabilities.

7. The method of claim 4, wherein the security vulnerability assessment is generated from scratch to incorporate the first vulnerabilities and not to incorporate the second vulnerabilities.

8. The method of claim 1, wherein said determining comprises:
obtaining an initial vulnerability assessment that is generated by a third-party application, wherein the initial vulnerability assessment comprises a list of vulnerabilities of code packages of the program; and
adjusting the list of vulnerabilities according to the classification of the code units of the program.

9. The method of claim 7, wherein the list of vulnerabilities comprises a list of Common Vulnerabilities and Exposures (CVEs) and corresponding risk scores.

10. The method of claim 1, wherein the in-process memory is a heap.

11. The method of claim 1, wherein said extracting comprises:
assigning high access privileges to the software agent, the high access privileges comprise root or administrator privileges in an Operating System (OS) of a host computer used to execute the program;
utilizing the high access privileges to attach the software agent to the process of the JIT engine; and
the software agent directly accessing the in-process memory via the process.

12. The method of claim 1, wherein the software agent is external to a runtime environment in which the execution of the program is performed.

13. The method of claim 1, wherein the classification of the code units is performed according to a granularity level of the security vulnerability assessment, wherein the granularity level comprises one of: a function granularity level, a library granularity level, or a package granularity level.

14. The method of claim 1 further comprising: generating a user interface presentation for the security vulnerability assessment of the program, wherein the user interface presentation prioritizes first vulnerabilities of the active code units over second vulnerabilities of the inactive code units.

15. An apparatus comprising a processor and coupled memory, said processor being adapted to perform:
executing a program by a Just-in-Time (JIT) engine in a runtime environment, the JIT engine is configured to execute the program without a-priori compiling the program, the JIT engine is configured to store runtime data of an execution of the program at an in-process memory, the JIT engine is configured to compile portions of the program based on the runtime data;
extracting, by a software agent that is external to a process of the JIT engine, the runtime data from the in-process memory;
based on the runtime data, performing a classification of code units of the program as active code units or inactive code units, wherein each of the active code units comprise at least one function that is indicated by the runtime data as being executed at least once, wherein each of the inactive code units is absent of any function that is indicated by the runtime data as being executed at least once; and
determining a security vulnerability assessment of the program, said determining is performed based on the classification of the code units of the program.

16. The apparatus of claim 15, wherein said processor is further adapted to aggregate the runtime data that is extracted from said extracting, with previously extracted runtime data of the program, thereby obtaining aggregated runtime data,
wherein the previously extracted runtime data was extracted by the software agent based on previous executions of the program, and
wherein the classification is performed based on the aggregated runtime data.

17. The apparatus of claim 15, wherein said determining the security vulnerability assessment comprises prioritizing first vulnerabilities that are associated with the active code units over second vulnerabilities of the inactive code units.

18. The apparatus of claim 17, wherein the security vulnerability assessment is generated from scratch to incorporate the first vulnerabilities and not to incorporate the second vulnerabilities.

19. The apparatus of claim 15, wherein said determining comprises:
obtaining an initial vulnerability assessment that is generated by a third-party application, wherein the initial vulnerability assessment comprises a list of vulnerabilities of code packages of the program; and
adjusting the list of vulnerabilities according to the classification of the code units of the program.

20. A computer program product comprising a non-transitory computer readable medium retaining program instructions, which program instructions when read by a processor, cause the processor to:
execute a program by a Just-in-Time (JIT) engine in a runtime environment, the JIT engine is configured to execute the program without a-priori compiling the program, the JIT engine is configured to store runtime data of an execution of the program at an in-process memory, the JIT engine is configured to compile portions of the program based on the runtime data;
extract, by a software agent that is external to a process of the JIT engine, the runtime data from the in-process memory;
based on the runtime data, perform a classification of code units of the program as active code units or inactive code units, wherein each of the active code units comprise at least one function that is indicated by the runtime data as being executed at least once, wherein each of the inactive code units is absent of any function that is indicated by the runtime data as being executed at least once; and
determine a security vulnerability assessment of the program, said determine is performed based on the classification of the code units of the program.
